(19) United States
(12) Patent Application Publication
(10) Pub. No.: US 2004/0030792 A1
(43) Pub. Date: Feb. 12, 2004

(54) Communication apparatus and method

(76) Inventor: Paul Febvre, Suffolk (GB)

Correspondence Address: STERNE, KESSLER, GOLDSTEIN & FOX PLLC, 1100 NEW YORK AVENUE, N.W., WASHINGTON, DC, 20005, US

(21) Appl. No.: 10/221,871

(22) PCT Filed: Mar. 21, 2001
(86) PCT No.: PCT/GB01/01247

(51) Int. Cl. G06F 15/16

(52) U.S. Cl. 709/230

(57) ABSTRACT

A method of transmission in a TDMA channel comprises transmitting first communications traffic using a first TDMA protocol in first selected periods of the TDMA channel and transmitting second communications traffic using a second TDMA protocol incompatible with the first TDMA protocol in second selected periods of the TDMA channel other than said first periods.

The present invention relates to a communication apparatus and method, particularly for allocating bandwidth to traffic using two or more different TDMA protocols.

The document U.S. Pat. No. 6,014,375 describes a TDMA system which can accommodate different vocoder formats while maintaining synchronisation with a control channel, by mapping different vocoder frame formats onto the same air interface frame format.

According to one aspect of the present invention, there is provided a method of allocating bandwidth between a first TDMA protocol and a second TDMA protocol, in which capacity is allocated to both protocols on the same TDMA channel.

Preferably, the allocation is made according to the respective bandwidth requirements under the two protocols. These requirements may be determined over a variable period.

Preferably, the allocation relates to a period which is the lowest common multiple of the frame periods of the two protocols.

Preferably, the periods allocated to the first and second protocols are interleaved so as to minimise delay in transmitters using either the first or second protocols.

Preferably, the allocation preserves the signalling requirements of the two protocols.

Specific embodiments of the present invention will now be described with reference to the accompanying drawings, in which:

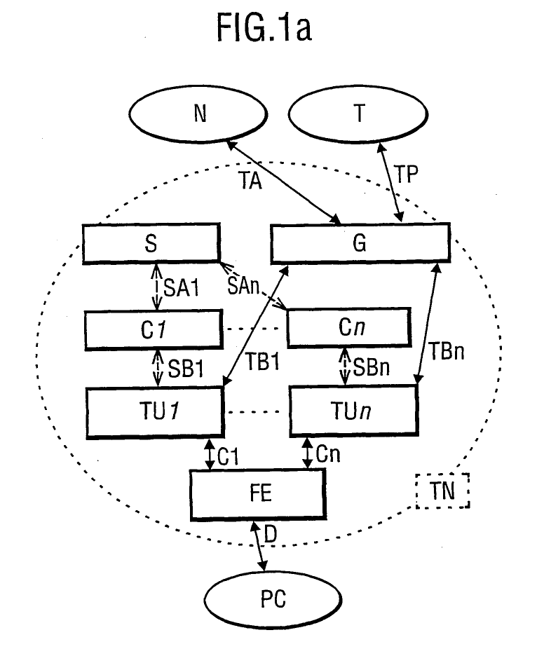

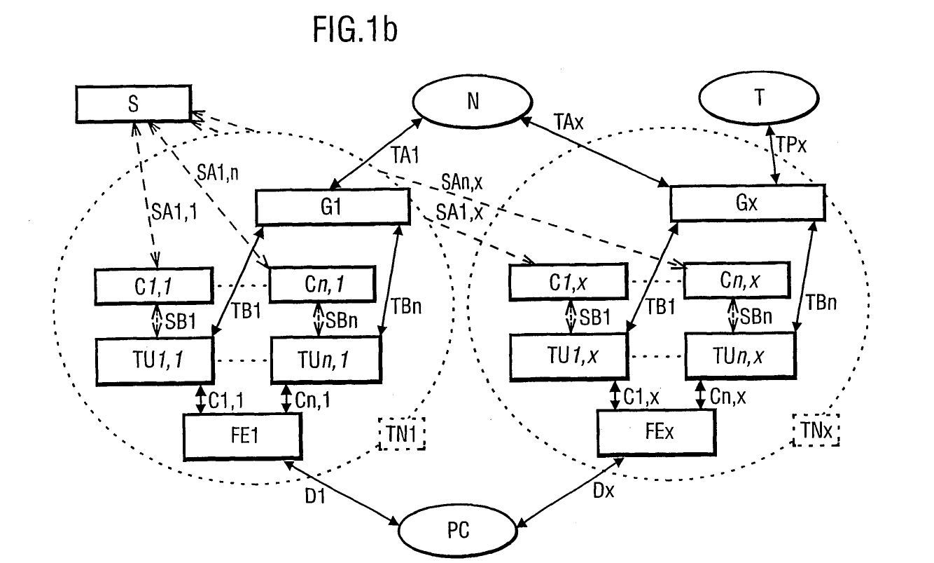

FIG. 1a is a schematic diagram of different functional elements in one embodiment of the present invention;

FIG. 1b is a schematic diagram of different functional elements in another embodiment of the present invention;

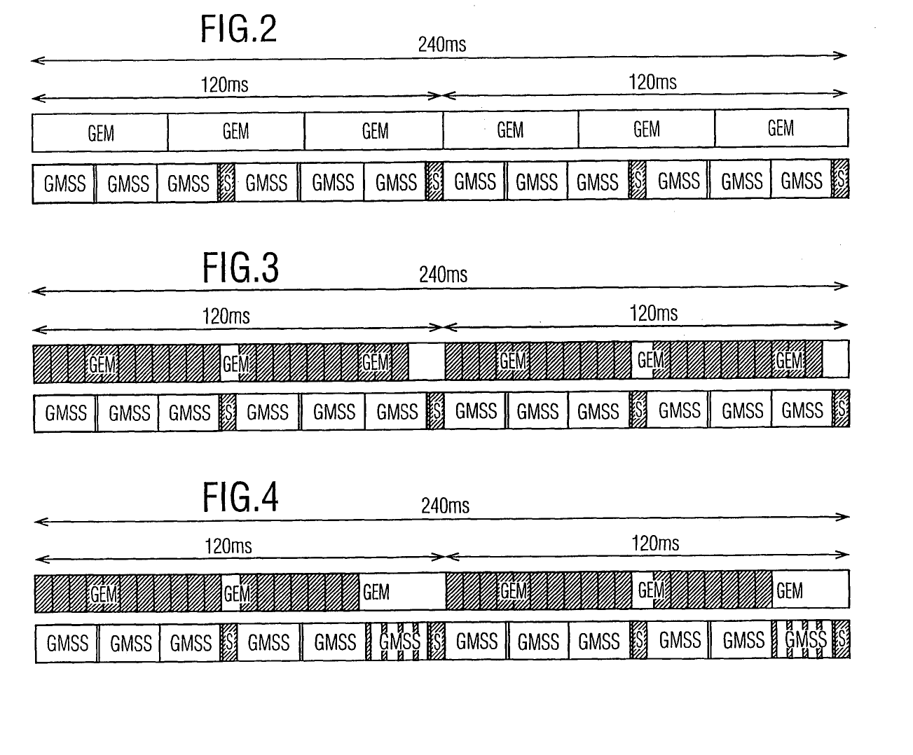

FIG. 2 is a timing diagram of first and second TDMA formats in the embodiment; and

FIGS. 3 to 9 are diagrams illustrating different allocation schemes according to the relative demands of transmitters using the first and second TDMA formats.

FIG. 1a shows an architecture of a TDMA network access node TN which operates with the two or more TDMA protocol systems for providing access to one or more physical channels PC from one or more networks N or terminal devices T. The network or networks N are connected to TDMA network access node gateways G through appropriate interfaces TA. The terminal device or devices T are connected to the TDMA network access node via a set of ports, which for the purposes of this embodiment are also represented by the gateways G, through appropriate interfaces TP. A set of connections TB1 to TBn support the transfer of traffic from the gateways G to respective transceiver units TU1 to TUn, each of which accesses the physical channels PC via an interface D to the network access node front-end equipment FE.

The transceiver units TU communicate via the physical channels with respective user terminals, each of which may only be able to receive and transmit using one TDMA system.

In one embodiment of the invention, the gateways or ports G and the front-end equipment FE are common to all transceiver units TU1 to TUn within the network access node TN.

The bandwidth allocation of each of the transceiver units TU to the physical channels PC is controlled by a respective controller C1 to Cn, according to allocation signals received from a supervisor S via respective signalling connections SA1 to SAn.

The supervisor S determines the time-divided allocation of the physical channels PC to the two or more different, mutually incompatible TDMA protocols, according to bandwidth demand signals received over the signalling channels SA.

In a further embodiment shown in FIG. 1b, there are a plurality of TDMA network access nodes TN1 to TNx, only one of which incorporates the supervisor S. Otherwise, the functions of each node TN are the same as those shown in FIG. 1a, and are distinguished by the suffix 1 to x in FIG. 1b.

In one more specific embodiment, the networks N are terrestrial networks through which communications sessions may be set up. The physical channels P are radio-frequency satellite channels for communication with wireless user terminals, some of which are only able to decode a first communications protocol, such as GMR-1 (or GEM), and others of which are only able to decode a second communications protocol, such as GMR-2 (or GMSS), the two protocols being mutually incompatible. The TDMA network access node may be an earth station, from which the transmissions are combined onto a common channel by a satellite. In the embodiment of the invention as shown in FIG. 1a, the supervisor S may be an internal function of the earth station, in which case all of the transceiver units TU will exist within the same earth station. In the further embodiment of the invention, as shown in FIG. 1b, the supervisor may be located at one of a set of earth stations and the signalling connections SA may be inter-station signalling links, which may also be supported via the same satellite, in which case the transceiver units TU may be distributed among different earth stations. However, the invention is applicable to satellite or terrestrial communication systems and also to wired communication systems such as cable communications systems. Within the scope of wireless communication systems, the physical channels may be of any media type, such as infrared, ultrasound or radio.

The more specific embodiment, involving the use of GEM and GMSS protocols, will now be described with reference to FIGS. 2 to 9 of the accompanying drawings. The GEM and GMSS protocols are TDMA protocols for providing GSM-equivalent mobile satellite services. The two protocols are mutually incompatible because they use different timing, bandwidth and modulation schemes. Nevertheless, it would be advantageous to be able to combine the two protocols on the same physical channel, to avoid wasting bandwidth. If each physical channel were reserved for only one protocol, spare capacity on one channel could not be used to satisfy bandwidth demand for traffic using another protocol.

In the GEM system, each frame (GEM) consists of eight time slots each of 5 ms duration. Each data burst occupies one time slot. The first time slot (TS1) of certain frames is used for broadcast signalling and timing acquisition. A multiframe consists of 16 frames having a total duration of 640 ms.

In the GMSS system, a multiframe of 240 ms consists of 52 frames, each consisting of eight time slots. Each data burst occupies one time slot in each of four successive frames (the same time slot number is occupied in each frame). For clarity, each group of four frames is indicated as a single block labelled GMSS in the figures. Frame numbers 13, 26, 39 and 52 are used in the GMSS scheme to carry signalling information.

The lowest common multiple of the frame periods of the two systems is 120 ms, corresponding to 3 GEM and 26 GMSS frames. The supervisor S allocates a timing plan for GEM and GMSS compatible bursts for each 120 ms period of each physical channel shared by these bursts, according to the relative demands for bandwidth using each protocol.

Specific timing plans for different ratios of GEM to GMSS traffic will now be described with reference to FIGS. 3 to 9, each of which shows two identical 120 ms time plans for a single frequency channel. While separate diagrams are used to show GEM and GMSS slots, it will be appreciated that the time slots allocated to the GEM and GMSS protocols occupy the same frequency channel. Allocated time slots (TS) are shown shaded.

In a first set of time plans shown in FIGS. 3 to 6, the first three slots of each 40 ms GEM frame are reserved for GEM traffic, to allow signalling information to be transferred. The time plans of FIGS. 3 to 6 are incremental, with progressively more bandwidth being allocated to GMSS traffic.

In the time plan shown in FIG. 3, frames 13, 26, 39 and 52 of the GMSS protocol are allocated to GMSS traffic, to allow GMSS signalling, using 2 out of 26 of the possible GMSS frames. In the GEM protocol, all slots are allocated apart from time slot 4 (TS4) in frame 2 and time slots 7 and 8 (TS7, TS8) in frame 3 of the three GEM frames of the time plan, using 21 out of 24 possible GEM time slots and avoiding collision between GEM and GMSS bursts.

In the time plan shown in FIG. 4, in addition to the GMSS frames allocated in the time plan of FIG. 3, frames 23 to 26 are allocated to GMSS traffic, so that 6 out of 26 possible GMSS frames are used. Time slots 4 to 6 are not allocated in GEM frame 3, so that 18 out of 24 possible GEM time slots are used.

In the time plan shown in FIG. 5, GMSS frames 13 to 16 are additionally allocated to GMSS traffic, using 10 out of 26 possible GMSS frames. Time slots 5 to 8 of GEM frame 2 are not allocated to GEM traffic, so that 14 out of 24 possible GEM time slots are used.

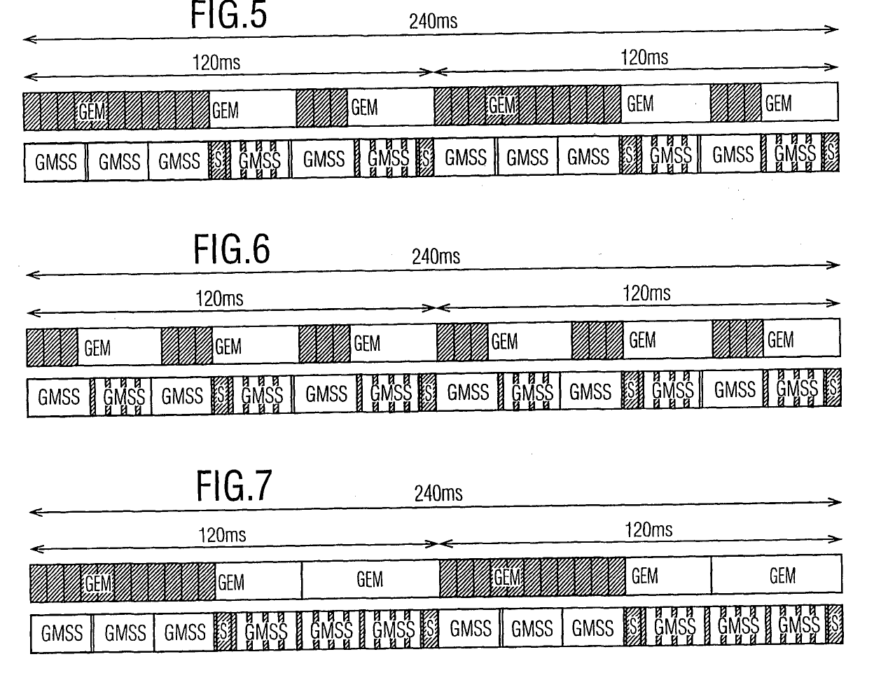

In the time plan shown in FIG. 6, GMSS frames 5 to 8 are additionally allocated to GMSS traffic, using 14 out of 26 possible GMSS frames. Time slots 4 to 8 of GEM frame 1 are not allocated to GEM traffic, so that 9 out of 24 possible GEM time slots are used.

In the set of time plans shown in FIGS. 7 to 9, 120 ms signalling boundaries are preserved for GEM and the 60 ms signalling boundaries for GMSS. The time plans of FIGS. 7 to 9 are incremental, with progressively more bandwidth being allocated to GMSS traffic.

In the time plan shown in FIG. 7, GMSS frames 13 to 26 are allocated to GMSS traffic, using 14 out of 26 possible GMSS frames. All of frame 1 and time slots 1 to 3 of GEM frame 2 are allocated to GEM traffic, so that 11 out of 24 possible GEM time slots are used.

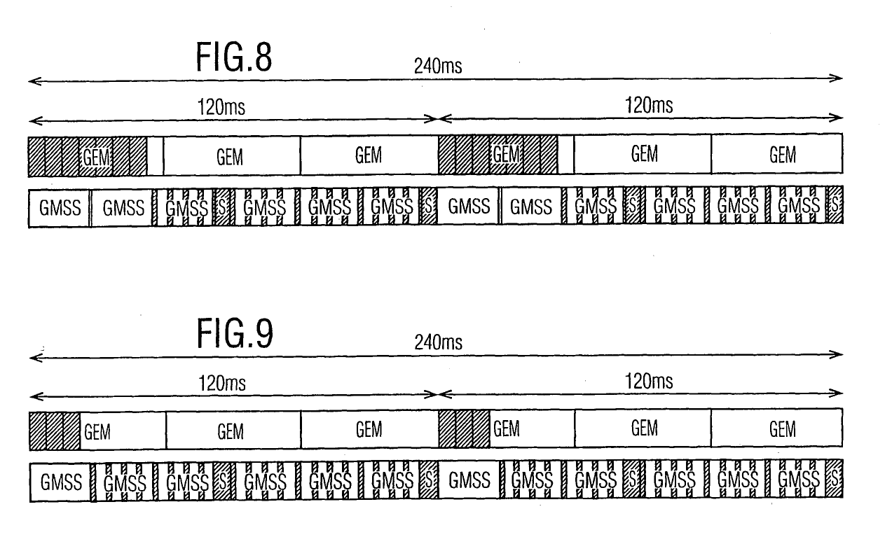

In the time plan shown in FIG. 8, GMSS frames 9 to 12 are additionally allocated to GMSS traffic, using 18 out of 26 possible GMSS frames. Only time slots 1 to 7 of GEM frame 1 are allocated to GEM traffic, so that 7 out of 24 possible GEM frames are used.

In the time plan shown in FIG. 9, GMSS frames 5 to 8 are additionally allocated to GMSS traffic, using 22 out of 26 possible GMSS frames. Only time slots 1 to 3 of GEM frame 1 are allocated to GEM traffic, so that 3 out of 24 possible GEM frames are used.

The bandwidth usage efficiencies and data and signalling intervals of the above time plans are summarised below in Table 1, together with the cases where all of the time plan is allocated to one protocol or the other.

TABLE 1

| | | | GEM | GMSS | | GMSS | GEM | GMSS | GEM |
|---|---|---|---|---|---|---|---|---|---|
| | GEM | GMSS | Capacity | Capacity | Efficiency | sig. int. | sig. int. | data int. | data int. |
| Fig. | time slots | time slots | % | % | % | (ms) | (ms) | (ms) | (ms) |
| — | 24 | 0 | 100.00 | 0.00 | 100.00 | — | 40 | — | 40 |
| 3 | 21 | 2 | 87.50 | 7.69 | 95.19 | 60 | 40 | — | 40 |
| 4 | 18 | 6 | 75.00 | 23.08 | 98.08 | 60 | 40 | 120 | 40 |
| 5 | 14 | 10 | 58.33 | 38.46 | 96.79 | 60 | 40 | 120 | 40 |
| 7 | 11 | 14 | 45.83 | 53.85 | 99.68 | 60 | 120 | 60 | 120 |
| 8 | 7 | 18 | 29.17 | 69.23 | 98.40 | 60 | 120 | 60 | 120 |
| 9 | 3 | 22 | 12.50 | 84.62 | 97.12 | 60 | 120 | 60 | 120 |
| — | 0 | 26 | 0.00 | 100.00 | 100.00 | 60 | — | 60 | — |

The time plan in FIG. 6 is not included in Table 1 and would only be used if low latency (delay) is required for both GEM and GMSS traffic, as it is less efficient than the other time plans; these other time plans are only a few percent inefficient, which is tolerable in most system designs.

The appropriate time plan may be selected by the supervisor S according to the latency as well as bandwidth requirements of the GEM and GMSS connections. In all cases, the maximum latency is 120 ms, which is acceptable for low data rate packet voice connections, while latency of 60 ms or better allows support for toll-quality voice connections. At least some of the time plans give a latency of 60 ms for GMSS and 40 ms for GEM and the supervisor may select these time plans according to an indication (for example, from the controllers C) of a low-latency requirement for GEM or GMSS traffic.

The supervisor may allocate time plans according to the bandwidth and latency requirements of the controllers C detected over an observation window of any duration equal to or greater than the time plan period. The length of the observation window may vary according to one or more factors, such as the detected rate of change in the bandwidth and/or latency requirements.

Where there are a relatively small number of possible time plans, the details of each possible time plan may be stored by each of the controllers and indexed by different codes, and the supervisor need only transmit the code to indicate a specific time plan.

In an alternative, less advantageous embodiment in which the lowest common multiple of the frame timings of the two different protocols is a very large multiple, such that it is impractical to create a single time plan for this multiple period, the supervisor may create a time plan based on an observation window period smaller than the lowest common multiple period, and each controller C then indicates to the supervisor S which time slots are required for signalling, and a total bandwidth demand for data. The supervisor then attempts to satisfy the signalling requirements within the observation window period and then allocate the remaining bandwidth to the two protocols according to their relative bandwidth demands. Where there is contention between the signalling requirements, the Supervisor may adopt one, or a combination of the following algorithms:

i) allocate the contended resources randomly to each system;

ii) systematically alternate between the protocols;

iii) allocate signalling resources on the basis of traffic demand;

iv) allocate on the basis of the regularity of signalling requests under each protocol;

v) allocate on the basis of efficiency of use of the surrounding data;

vi) allocate using priority information;

vii) allocate using a-priori knowledge about the signalling behaviour itself.

Aspects of the present invention are applicable to hybrid TDMA protocols, such as CDMA-TDMA.

1. A method of transmission in a TDMA channel, comprising:
transmitting first communications traffic using a first TDMA protocol in first selected periods of the TDMA channel; and
transmitting second communications traffic using a second TDMA protocol incompatible with the first TDMA protocol in second selected periods of the TDMA channel other than said first periods.

2. A method as claimed in claim 1, wherein the first periods include periods required for signalling under the first TDMA protocol and the second periods include periods required for signalling under the second TDMA protocol.

3. A method as claimed in claim 1 or claim 2, wherein the first and second periods are interleaved within a period which is the lowest common multiple of the frame periods of the first and second TDMA protocols.

4. A method of controlling access to a TDMA channel by transmissions under two or more mutually incompatible TDMA protocols, including:
determining an allocation of said transmissions under each of the protocols to the TDMA channel, wherein the allocation defines, within a predetermined interval of the TDMA channel, first and second periods reserved exclusively for said first and second TDMA protocols respectively, and
controlling said transmissions in accordance with said allocation.

5. A method as claimed in claim 4, wherein the allocation is determined according to the bandwidth requirements of transmissions under the two or more protocols.

6. A method as claimed in claim 5, wherein said bandwidth requirements are detected over a variable period.

7. A method as claimed in any one of claims 4 to 6, wherein the first periods include periods required for signalling under the first TDMA protocol and the second periods include periods required for signalling under the second TDMA protocol.

8. A method as claimed in any one of claims 4 to 7, wherein the first and second periods alternate within an interval which is the lowest common multiple of the frame periods of the first and second TDMA protocols.

9. A method as claimed in claim 8, wherein the delay between successive first or second periods is no greater than said interval.

10. A method as claimed in any preceding claim, wherein the protocols include the GMR-1 and GMR-2 protocols.

11. Apparatus arranged to perform a method as claimed in any preceding claim.

12. Software for performing a method as claimed in any one of claims 1 to 10 when executed by suitably arranged apparatus.
